(19) United States
(12) Patent Application Publication
(10) Pub. No.: US 2020/0342726 A1
(43) Pub. Date: Oct. 29, 2020

(54) GLAZING HAVING SENSORS

(71) Applicant: AGC GLASS EUROPE, Louvain-La-Neuve (BE)

(72) Inventors: Arnaud ISERENTANT, Vieux-Genappe (BE); Maxime COLLIGNON, Gottignies (BE); Nicolas CHORINE, Haasrode (BE); Patrick AYOUB, Louvain-La-Neuve (BE)

(73) Assignee: AGC GLASS EUROPE, Louvain-La-Neuve (BE)

(21) Appl. No.: 16/765,366

(22) PCT Filed: Nov. 22, 2018
(86) PCT No.: PCT/EP2018/082266

§ 371 Date: May 19, 2020

(30) Foreign Application Priority Data
Nov. 22, 2017 (EP) 17203106.4

(51) Int. Cl. G08B 13/16; B32B 17/10; G01N 29/04; G01N 29/14; G01N 29/24; G01N 29/42; G08B 13/04; B60J 1/00; B60J 1/02

(52) U.S. Cl. CPC G08B 13/1672; B32B 17/10036; G01N 29/045; G01N 29/14; B60J 1/02; G01N 29/42; G08B 13/04; B60J 1/006; G01N 29/2437

(57) ABSTRACT

An automotive glazing having an exterior face and an inner face comprising at least one sensor for detecting an impact and discriminating a breakage/non breakage on the glazing and generating a signal representative of the impact, the sensor being connected to an electrical connector, to provide external access to the signal generated by the sensors. The sensor is reusable and mounted on the inner face of the glazing.

This invention relates to a glazing, e.g. a window, having sensors responsive to physical changes more particularly responsive to physical impact. More particularly, the invention related to an automotive window and more particularly an automotive windshield having sensors to monitor the breakage in real time.

Today when the glazing has undergone an impact, the driver or the owner of the vehicle is not able to evaluate if the glazing has to be replaced or only to be repaired. The driver, after an impact goes generally to a vehicle glass repair company who evaluates if the glazing should be repaired or replaced. The replacement of automotive glazing represents a substantial cost for insurances with a limit control of costs. Thus, there is a need to inform the driver or the owner of the vehicle or potentially insurances, of the impact and the severity of the impact as rapidly as possible to avoid an over cost by repairing in time the glazing instead of replacing it.

It would be advantageous, therefore, to provide a glazing having sensors to monitor physical changes as such an impact to evaluate if the glazing has to be repaired or replaced.

The use of sensors to detect an impact on an automotive glazing is known. For example US20100163675, described a laminated glazing comprising between the glass sheets, a sensor to detect an impact or any physical modification of the glazing. Since, the sensor(s) is laminated into the glazing, when the glazing has to be replaced the sensor is also replaced resulting an additional cost and a loss of the sensor. Thus, if the sensor is damaged and/or if the glazing is damaged, both have to be replaced. In case of damage of the glazing, the sensor cannot be reused to the new replaced glazing.

Thus, there is a need of efficient sensor for detecting or detecting and locating the impact on the glazing that may be reused in case of breakage of the glazing.

For simplicity, the numbering of the glass sheets in the following description refers to the numbering nomenclature conventionally used for glazing. Thus, the face of the glazing in contact with the environment outside the vehicle is known as the side 1 and the surface in contact with the internal medium, that is to say the passenger compartment, is called face 2. For a laminated glazing, the glass sheet in contact with the outside environment the vehicle is known as the side 1 and the surface in contact with the internal part, namely the passenger compartment, is called face 4.

For avoidance of doubt, the terms “external” and “internal” refer to the orientation of the glazing during installation as glazing in a vehicle.

Also for avoidance of doubt, the present invention is applicable for all means of transport such as automotive, train, plane...

This present invention relates to an automotive glazing having an external and internal faces comprising at least one sensor mounted to detect or to detect and locate an impact on the glazing.

According to the present invention, the sensor is mounted on the internal face of the glazing to generate a signal representative of the said impact, the sensor being connected to an electrical connector, to provide external access to the signal generated by the sensor.

According to an embodiment of the present invention, the glazing is an automotive laminated glazing comprising at least a first and a second glass sheets laminated with at least on thermoplastic interlayer, the glazing having at least one sensor for detecting impacts or detecting and locating an impact in one or more of the sheets.

As used herein, spatial or directional terms such as “inner”, “outer”, “left”, “right”, “up”, “down”, “horizontal”, “vertical”, and the like, relate to the invention as it is shown in the drawing on the figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the property desired and/or sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. Also, as used herein, the term “positioned over” or “mounted over” means positioned on or mounted over but not necessarily in surface contact with. For example, one article or component of an article “mounted over' or positioned over” another article or component of an article does not preclude the presence of materials between the articles, or between components of the article, respectively.

Non-limiting embodiments of the invention will be directed to an automotive laminated transparent glazing, and in particular to an automotive windshield. The invention, however, is not limited to any particular type of automotive glazing. Still further, the invention is not limited to the material of the layers or sheets of the glazing, and the layers or sheets can be made of, but not limited to, cured and uncured plastic sheets; annealed, heat strengthened, and heat and chemically strengthened, clear, colored, coated and uncoated glass sheets. Still further the invention can be practiced on windows having opaque sheets, e.g. glass sheets having an opaque coating, and combinations thereof.

The windshield may include a first glass sheet laminated to a second glass sheet by a first interlayer.

The windshield or the glazing may be provided with heat to remove fog from, and/or to melt ice on, the outer surface of the windshield or the glazing.

Generally the glass sheets of the windshield are clear may be chemically strengthened glass sheets; however, the invention is not limited thereto, and the glass sheets can be heat strengthened or heat tempered glass sheets. Further as is appreciated, the invention is not limited to the number of glass sheets, thermoplastic interlayers that make up the windshield and the windshield can have any number of sheets and/or interlayers.

According to the present invention, the sensor for detecting impacts or detecting and locating an impact is a sensor measuring the vibration and/or acoustic signature of the glazing and in particular embodiment the vibration and/or acoustic signature of the windshield. The sensor may be an accelerometer, a microphone or a piezo electric sensor. In a preferred embodiment, the sensor is a piezoelectric sensor. One example of a sensor that may be used is the sensor LDT0-028K manufactured by the company TE Connectivity—Measurement Specialties or 7BB-20-6L0 manufactured by the company Murata.

According to one embodiment of the present invention, the at least one sensor is mounted and mechanically fixed to the PCB for system robustness.

According to another embodiment of the present invention, the at least one or multiple sensors provided preferably with a foam are mounted on a bracket and connected to a Printed Circuit Board (PCB) and a cover.

According to one embodiment of the present invention, the at least one sensor is provided with a foam on its surface facing the glazing, the foam pushing the sensor on the glass.

According to one embodiment on the present invention, two sensors are provided in a central unit here referred to as a bi-sensor device. The bi-sensor device is suitable for detecting an impact and discriminating a breakage/non breakage situation. This bi-sensor device may also estimate the location of the impact on the glazing as for example left or right side of the glazing. The bi-sensor device may be around 3 cm×11 cm. The device could even be wider (more spacing between the sensor allows for more accurate detection of the left/right location) or higher (to allow for larger sensors).

According to the another embodiment of the present invention, more than two sensors are mounted on a Printed Circuit Board (PCB) also called multiple sensors. The sensors are then preferably electrically connected on the PCB and mechanically attached to the PCB for system robustness.

For example, the multiple sensors comprise three to ten sensors, preferably three to six sensors, provided one the glazing and more particularly on an automotive glazing such as a windshield. This multisensor device is suitable for detecting an impact, discriminating a breakage/non breakage situation, and for locating more accurately the impact on the glazing particularly inn the horizontal position of the glazing (X position according to the X/Y axis). The multiple sensors can be placed on separate PCBs or on the same PCB. In a particular embodiment, the multisensors device may comprise a bi-sensor device with further two external sensors physically separated via a cable.

In one embodiment of the present invention, one sensor is used per PCB here referred to as a monosensor device. The monosensor device is suitable for detecting an impact and discriminating a breakage/non breakage situation. In a preferred embodiment, the monosensor device forms a square having a size between 1 cm×1 cm and 10 cm×10 cm, and more preferably between 1 cm×1 cm and 6 cm×6 cm or forms a circle of 1 to 10 cm diameter and more preferably between 1 cm to 6 cm.

In another embodiment, multiple sensors, typically 3 to 10, preferably 3 to 6 are mounted on one glazing and particularly mounted on a windshield. Particularly, the multiple sensors are mounted on at least one Printed Circuit Board (PCB). The multiple sensors may be mounted on separated PCB or on one PCB to provide multiple multisensors device(s). Resulting multisensor device(s) is suitable for detecting an impact, discriminating a breakage/non breakage situation, and for locating the impact on the windshield. Thus, if the impact is located in the field of view of the driver, the impact should be repaired or if the impact is important should be replaced as soon as possible to guarantee the safety of the occupants of the vehicle and to avoid propagation of the impact leading to a need of replacement.

In a preferred embodiment of the present invention, the sensors are aligned on a long and thin PCB to form a thin and discrete bar of sensor of approximate dimensions:Length:20 to 50 cm, width=2 to 10 cm. The sensors aligned on the thin PCB are then spaced, interspacing is typically between 10 to 20 cm.

In both mono-sensor and multi-sensors designs, the devices are mounted on the glazing and particularly on the windshield glazing, on the internal surface inside the car, commonly called face 4, to protect the sensor from harsh environment, in a position on the windshield where the mono-sensor or multiple-sensors as little as possible the driver's field of view. It is understood that the monosensor or the multisensors is mounted on the glazing wherein a zone where they affect as little as possible the driver's field of view. Preferably, the monosensor or multisensors are mounted in the upper part of the windshield or bottom part. More preferably, the monosensor or multisensors are mounted in a discrete place on the inner surface of the glazing for example in a corner of the glazing.

In a particular embodiment the mono-sensor or multi-sensors are mounted on one side of the PCB and all the required electronics on the other side of the PCB therefore allowing a direct contact between the sensor and the glass.

According to the present invention, the PCB comprising the monosensor or the multiple sensors also called mono or multisensors device, is fixed to the glass. The PCB may be glued directly to the glass or preferably the PCB is fixed to the glazing through a housing protecting the PCB that is glued to the glass.

Preferably, in one embodiment of the present invention, the PCB comprising the monosensor or the multiple sensors is fixed thanks to a double sided adhesive tape or pressure sensitive double sided tape. More preferably, a repositionable double sided tape may be used. The lower adhesion side will allow multiple installations/remove of the device. This kind of tape is very advantageous since it does not deteriorate the performance of the sensor. Also, if the sensor (mono or multi) is damaged it can be easily replaced by another one without changing completely the glazing or damaging the glazing. This tape is chosen to be resistant to temperatures higher than 70° C., ideally up to 120° C. and resistant to UV light. Examples of such tapes are available by company 3M.

In another embodiment of the present invention, the low adhesion side of the tape can be replaced by microsuction tape, the other side being a classical adhesive tape. Thus, the mono or multisensors device (PCB and sensors) may be installed/removed very easily reducing thus drastically the cost if the sensors is damaged or the glazing has to be replaced.

In one non-limiting embodiment of the invention, one or more impact sensors are mounted adjacent each one of the sides of the glass sheet. In this non-limiting embodiment of the invention, each of the impact detectors include a piezoelectric material, e.g. but not limited to a piezoelectric crystal. When the piezoelectric material is exposed to vibration, e.g. vibration of the glass sheet caused by a stone hitting the outer surface of the glass sheet, the piezoelectric material undergoes a compression or distortion and, as a result, produces an electric field, which can be used to activate or to cause an alarm and/or a recorder to be activated to announce and/or record the hit or impact. Further, using three or more impact detectors the location of the impact on the surface of the windshield can be identified, as discussed below.

The discussion is now directed to the placement of sensors on selected components of the glazing and particularly the windshield, to monitor the breakage and/or performance of the selected components of the windshield, in accordance to the teachings of the invention.

In one non-limiting embodiment of the invention, the windshield is provided with an impact sensor that generates a signal when an object hits or impacts the windshield, e.g. but not limiting to the invention, hits the outer surface of the windshield or more generally speaking the glazing. For example and not limiting to the invention, as the automotive foreign objects, e.g. stones are propelled through the air and can hit the outer surface of the windshield. The impact sensor mounted on internal face of the glazing (face 2 for one sheet glazing or face 4 for a laminated glazing) and more particularly on the windshield can be used to indicate that one or more foreign objects have hit the windshield, and optionally the location on the outer surface where the hit or impact occurred and the relative energy of the impact on the surface of the windshield.

Furthermore, a software may be linked to the impact sensor thus, if a stone or an object hits the glazing , the importance of the shock may be monitored in order to detect if the glazing have to be replaced or just repaired. The software may for example offer a list of glazing advantageous for the car's owner for example to enhance performances of the glazing (weight, thermal comfort, save energy consumption . . . ).

The present invention concerns also a method to analyze the signal generated by the sensor (mono or multiple) after an impact on the glazing when an object hits or impacts the windshield, e.g. but not limiting to the invention, hits the outer surface of the glazing and particularly the windshield. According to one embodiment of the present invention, the sensor raw output signal will be submitted to multiple signal processing steps comprising:
applying a high pass filter to the raw signal. Thus the low frequency noise related to unwanted effects (like engine noise, wheels and road noise, music etc.) may be eliminated to keep only the relevant signal.
applying a signal amplification to increase the signal level from tens or hundreds of millivolts to levels compatible with standard Analog to digital conversion stages typically of 0 to 5V.
multiple amplifications could also be applied to the same signal, thereby generating multiple copies of the same signal with different amplification levels. This allows to cope with the fact that the sensor will sense signals with varying amplitudes depending on how far away the impact occurred from the location of the sensors. With different gains applied to the signal, the chance is higher that at least one copy of the signal will at least be detected and not be clipped.
an offset can be applied on the signal so that both the positive and negative variations of the signal can be captured by an ADC (Analog to Digital Converter) that is aimed at working only with positive signal.
using a microcontroller to manage the functionalities on the PCB. The microcontroller generally includes the ADC that will turn the analog signal into a digital signal that can further be processed by the microcontroller and other electronic systems.
communicating to an external control unit. For example, relevant components and protocols (like LTE chips, Bluetooth chips, Sim card readers, antennas etc.) may be used,
using a threshold level to capture a relevant signal situation, the signal of the sensor (or the sensors) is (are) ignored when below the threshold level and different systems (amplifier, comparator, microcontroller, communication channels etc.) can be set to sleep mode to reduce power consumption,
several different thresholds can be used to whether the signal reaches certain levels. In a particular embodiment, two thresholds are used and form a “window” comparator. While the signal remains within the boundaries of the window, the system may continue to sleep. If the signal crosses any of the boundaries (i.e. become greater than the upper threshold or less than the lower threshold), the system will wake up and start capturing the signal,
when an impact occurs, the threshold is passed, the different systems are awaken. A record of all the sensors is made for a given time, of about 50ms, preferably 5 to 10 ms after the impact. These signals are called the “traces”.

According to the present invention, the signal is processed. The traces may either be processed locally on the PCB using the microcontroller. An algorithm may be used to extract the useful information. Examples of outputs generated from the algorithm may be: impact occurrence, breaking or non-breaking impact, X and Y location of the impact/breakage. According to one embodiment of the present invention, the output generated is transmitted to the user and/or to a control system using communication means as such LTE, Bluetooth, etc . . .

In another embodiment of the present invention, the raw sensor signals are transmitted though communication means as such LTE, Bluetooth, etc.. to another storage and processing unit (ex. Cloud). In that case, the algorithm is executed at this storage and processing unit level. The relevant information is then transferred to the user or to a control system. Thus, advantageously, the algorithm may be adapted/improved or updated more easily.

The information may be forwarded directly to a smartphone in order for example to inform the driver of the nearest center to replace the glazing or which kind of glazing will be more adapted to the automotive regarding the energy consumption, thermal comfort. . . .

In one non-limiting embodiment of the invention, the information is sent to the vehicle console that includes a computer having software to read and analyze the signals from the sensors or detectors to monitor and/or determine the performance of the components of the windshield. Monitor provides visual display, and speaker provides audible information regarding the performance of the windshield, and/or individual components of the windshield. The console can include an alarm to bring attention to the monitor. Placing the console in the automotive provides the personnel within the automotive with real time performance of the windshield. The information may advantageously be transfer to driver's smartphone.

In another non-limiting embodiment of the invention, the console has a wireless transmitter and receiver; the transmitter transmits signals to a transmitting tower. The signals carry data on the performance of the windshield. The tower transmits a signal carrying the data on the status of the windshield to a satellite. The satellite transmits a signal carrying the data on the performance of the windshield to a control center. The data received is studied and the appropriate action to be taken is scheduled. In one non-limiting embodiment of the invention, based on the information received, personnel at the control center determine what action, if any, is needed. If action such as repairs to the windshield or replacement of the windshield, is needed, a signal providing a repair schedule is transmitted to the satellite. The satellite transmits a signal having the repair schedule to the tower. The tower transmits a signal having the repair schedule to the console and to a maintenance center geographically close to the designated repair location usually the next scheduled stop for the automotive to arrange to have all parts, equipment and personal need at the designated repair location.

In one non-limiting embodiment of the invention, if the data from the sensors indicate that the windshield has to be replaced, the repair schedule can include shipment of the windshield to the next scheduled stop of the automotive;

if the windshield has to be replaced with some urgency.

According to one preferred embodiment of the present invention, the PCB comprising the monosensors or multiple sensors also called here as monosensor or multiple sensors device is protected by a cover box or a housing box. The cover or housing box is preferably mounted around the PCB to protect the monosensor or multiple sensors device but also to improve esthetics and better integration in the car. The cover or housing box may be made of plastic and or composite material.

The cover box can also include holes equipped with light pipes, allowing some LED's on the PCB to provide visual indication of the activity or status of the PCB.

The tape to fix the PCB as described above may cover the whole surface of the back of the housing. However, in one particular embodiment, the tape is located only on the sides of the back of the housing, for example on a 1 cm wide area between the edges of the sensors and the edges of the housing. This allows for an easier removal of the device from the glazing.

In another embodiment, a low adhesion side of the tape can be replaced by microsuction tape, the other side being a classical adhesive tape. This allows multiple installations/desinstallations of the device.

According to one embodiment of the present invention, the at least one sensor is provided with a foam on its surface facing the glazing, the foam pushing the sensor on the glass. The foam between the sensors and the housing then presses the sensor to the glass.

The cover or housing box may comprise some holes to evacuate heat to avoid an overheating of sensors and electronics (mono or multiple) device. More preferably, the back of the housing comprises a hole smaller than the size of the foam in order to apply a force to the foam. Thus, the foam provided on its face facing the interior of the automotive with the sensors is first fixed to the glazing and then the back of the housing is fixed to the glazing, the foam projecting partly through the hole, presses the sensor to the glass.

According to an embodiment of the present invention, the foam is a foam resisting to a temperature comprised between −20° C. and 105° C. and resisting to the UV and hydrophobic. The foam may be for example made of cellular rubber with a compression deflection comprised between 12 and 28 KPa (according to the standard ASTM D1056), a vacuum-water absorption less or equal to 10% (ASTM D1056). The foam may be a solid disc whereon the sensor is provided or a circle surrounding the sensor.

The cover or housing box is preferably attached to the PCB thanks to mechanical means as such bolts, glue . . . or through magnetic means. According to one embodiment of the present invention, a cable is provided from the car battery to the PCB allowing to power the sensor device and its electronics.

In another embodiment, the PCB features an external (for instance a micro-USB port) allowing a “standard” power cable to be connected to the PCB. Such cables need not necessarily be connected to the car battery but may instead be connected to a USB port in the car or to a cigarette lighter adapter providing one or more USB ports.

According to a preferred embodiment of the present invention, energy harvesting techniques may be used to power the sensor device and its electronics. This energy management may be reduced to minimum values particularly in sleep mode. In that case, power consumption may be as low as 20 mW, even below 5 mW. In another embodiment, a small solar cell and a battery may be used to avoid any cabling to the sensor. In a preferred embodiment, a solar cell and one or more supercapacitors are used. In a particular embodiment, a combination of two supercapacitors are used such as a small supercapacitor which will charge fast and make the system available, when completely discharged, within a few minutes (typically less than 5 minutes) after light is received again on the photovoltaic cells and a bigger supercapacitor that will charge slowly but will instead offer large capacity and longer autonomy.

As can be appreciated, the invention is not limited to the manner in which power is provided to the sensors and any circuit arrangement can be used in the practice of the invention, e.g. and not limiting to the invention one electrical contact of the sensors can be mounted on any one or more of the sheets of the windshield and directly connected to one pole of a power supply dedicated to providing electrical power to the sensor(s) and the other contact of the detectors connected to the other pole of the dedicated power supply. As can be appreciated, the invention is not limited to the type of power supply used in the practice of the invention and the power supply can generate alternating or direct current.

In one preferred embodiment of the invention, one or more sensors or detectors are resisting to a temperature preferably above 120° C. or more.

In another embodiment of the invention, one or more sensors are microphone sensors or detectors.

The present invention will now be more particularly described with reference to drawings and exemplary embodiments, which are provided by way of illustration and not of limitation. The drawings are a schematic representation and not true to scale. The drawings do not restrict the invention in any way. More advantages will be explained with examples.

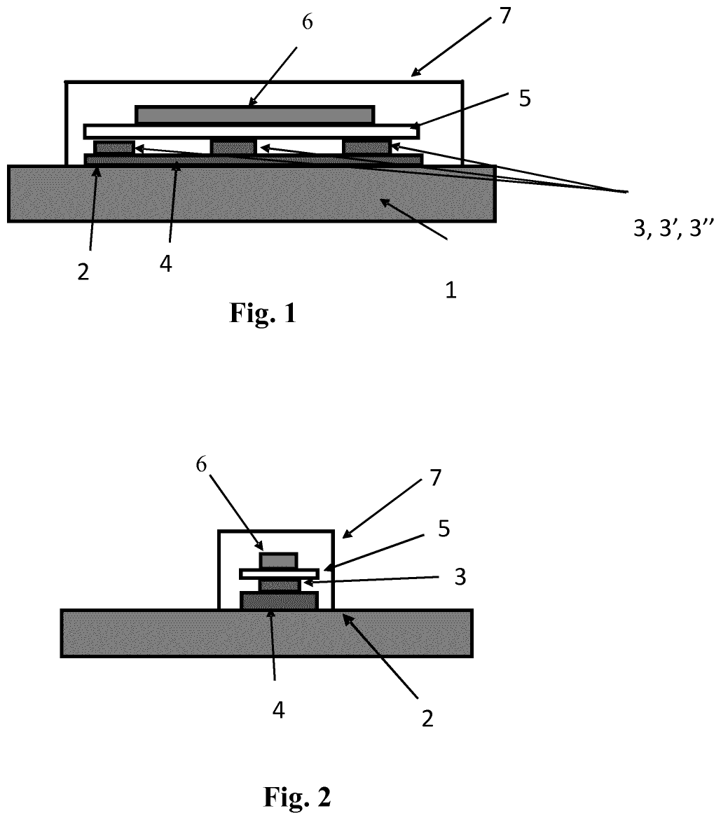

FIG. 1 is a plan view of one example of a multisensors device fixed to a glazing according to one embodiment of the present invention.

FIG. 2 is a plan view of another example of a monosensor device fixed to a glazing according to one embodiment of the present invention.

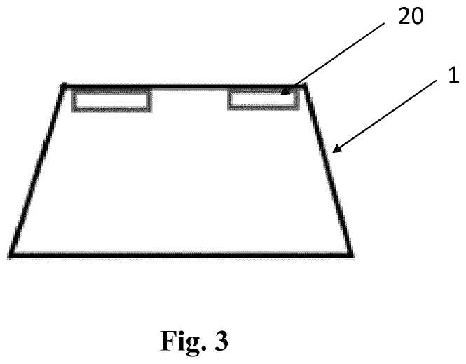

FIG. 3 is a plan view of a windshield comprising multiple multisensors devices according to one embodiment of the present invention.

Referring to the FIG. 1 and FIG. 2 according to a first and a second embodiments of the present invention, the glazing panel 1 is an automotive laminated glazing more particularly a windshield. According to a preferred embodiment of the invention, the automotive glazing is a laminated glazing comprising an exterior and an interior glass sheets laminated with at least one thermoplastic interlayer. For a laminated glazing, the glass sheet in contact with the outside environment the vehicle is known as the face 1 and the surface in contact with the internal part, namely the passenger compartment, is called face 4. The details of the windshield are not shown here in order to not unnecessarily burden the drawing.

According to the FIG. 1, the windshield carries on its face 4 ie the inner face of the laminated glazing, referred in drawing as reference 2, multiple sensors 3, 3′, 3″. Sensors are fixed to the glazing 1 through a double sided adhesive tape 4. As mentioned above, the mean to fix the sensor(s) to the glazing may be a pressure sensitive double sided tape, more preferably, a repositionable double sided tape. Thus, the multiple sensors devices 10 may be re-used in case of damage of the glazing.

It is understood that glazing of the present invention may be a flat or curved panel to fit with the design of the car. The pane of glass can be tempered to respect with the specifications of security. A heatable system, for example a coating or a network of wires, can be applied on the glazing to add a defrosting function for example. Also, the pane of glass can be a clear glass or a colored glass, tinted with a specific composition of the glass or by applying a coating or a plastic layer for example.

According to the present invention, the multiple sensors 3, 3′, 3″ are fixed to the printed circuit board commonly called PCB 5 through well-known technologies to provide a multisensors device 10 (multiple sensors fixed to PCB). On the PCB 5, electronic components 6 are provided to process the signals received from the multiple sensors 3, 3′, 3″ . . . as described below. Preferably, the multiple sensors device 10 are provided on one side of the PCB and the electronic components 6 are provided on the opposite side of the PCB 5 therefore allowing a direct contact between the sensors and the surface of the glass.

For example, the electronic components 6 may include a high pass filer, a signal amplifier, a microcontroller or other relevant components for communication to an external control unit.

To protect the multiple sensors device 10 from damages, a cover box or a housing 7 is provided. The cover or housing box 7 is preferably mounted around the PCB 5 to protect the monosensor device 20 or multisensors device 10 but also to improve esthetics and better integration in the car. The cover or housing box 7 may be made of plastic and or composite material.

The cover or housing box 7 may comprise some holes to evacuate heat to avoid an overheating of sensors (mon or multiple) device. The cover or housing box 7 is preferably attached to the PCB 5 thanks to mechanical means as such bolts, glue . . . or through magnetic means. According to one embodiment of the present invention, a cable is provided from the car battery to the PCB 5 allowing to power the sensor device 10 and its electronics. A wireless system may be used to power the multisensors device 10 as described above.

According to the present invention, the multisensors device 10 is suitable for detecting an impact, discriminating a breakage/non breakage situation and for locating the impact on the windshield. According to one embodiment of the present invention, multiple sensors 3, 3′, 3″ . . . are aligned along more than one thin PCB 5 in order to obtain better signal and in order to well defined the location of the impact. Preferably, the interspace between sensors on the thin PCB is about 20 cm. It is understood the space between the sensors 3, 3′, 3″ . . . fixed to PCB 5 has to be adapted to obtain the best signal and will also depend on the type of sensors used. The multisensors device 10 is provided preferably in a discrete zone on the windshield for an aesthetic point of view and of course not in the driver's field of view. The preferred location of the multiple sensors device is well described above. Preferably, multiple sensors devices 20 are provided on the upper or bottom side of the windshield 1 or in lateral positions as shown in FIG. 3 as an example. The number of multiple sensors 20 device will be fixed based on the sensors used and also the quality of signal required.

According to the FIG. 2, the difference between the FIG. 1 and the FIG. 2 is based on the sensor device. According to FIG. 2, the sensor 3 is fixed to the PCB 5 to form the monosensor device 20. The monosensor device 20 is provided on the face 4, here referred as reference 2 in the FIG. 2 of the windshied 1. The sensor 3 is fixed to the glass 2 on the inner face and the PCB 5 in the same way described for FIG. 1. The use of monosensor device 20 allow to detect a breakage/no breakage situation. Since the monosensor device 20 is smaller than the multiple sensors device 10, the monosensor device 20 may be placed, further to zones described above, in some other parts of the glazing 1 as for example in the camera zone.

The invention is not limited to the embodiments of the invention presented and discussed above which are presented for illustration purposes only, and the scope of the invention is only limited by the scope of the following claims and any additional claims that are added to applications having direct or indirect linage to this application.

1. An automotive glazing having an exterior face and an inner face comprising at least one sensor for detecting an impact and/or discriminating a breakage/non breakage on the glazing and generating a signal representative of the said impact, the sensor being connected to an electrical connector, to provide external access to the signal generated by the at least one sensor,
wherein the sensor is reusable and mounted on the inner face of said glazing.

2. The automotive glazing according to claim 1, wherein the glazing comprises multiple sensors for detecting and locating the impact and/or discriminating the breakage/non breakage on the glazing and generating the signal representative of the said impact.

3. The automotive glazing according to claim 1, wherein the at least one sensor for detecting or detecting and locating the impact is a sensor measuring a vibration and/or acoustic signature of the glazing.

4. The automotive glazing according to claim 1, wherein the at least one sensor is chosen amongst an accelerometer a microphone, and a piezo electric sensor.

5. The automotive glazing according to claim 1, wherein the at least one sensor is mounted and mechanically fixed to a printed circuit board (PCB) to form a monosensor device.

6. The automotive glazing according to claim 2, wherein the multiple sensors are aligned on a long and thin PCB to form a thin multisensors device.

7. The automotive glazing according to claim 1, wherein the monosensor device is fixed to the glazing on the inner face by a double sided adhesive tape or pressure sensitive double sided tape.

8. The automotive glazing according to claim 1, wherein the monosensor device is removable from the glazing and reusable on another glazing.

9. The automotive glazing according to claim 1, wherein the monosensor device is mounted on an edge of the glazing.

10. The automotive glazing according to claim 1, wherein the monosensor is protected by a cover box.

11. The automotive glazing according to claim 1, wherein the glazing is a laminated glazing on which the monosensor device is mounted on an inner sheet on its inner face.

12. The automotive glazing according to claim 18, wherein the glazing comprises multiple multisensors devices.

13. A method to analyze the signal generated by the sensor according to claim 1 after an impact on the glazing, the method comprising:
applying a high pass filter to a raw signal,
applying a signal amplification to increase the a signal level from tens or hundreds of millivolts to levels compatible with standard Analog to digital conversion stages typically of 0 to 5V,
using a microcontroller to manage the functionalities on a PCB,
communicating to an external control unit, and
using a threshold level to capture a relevant signal situation.

14. The method according to claim 13, wherein the method further comprises:
extracting an impact occurrence and/or breaking or non-breaking impact information using an algorithm when a monosensor device is used.

15. A re-usable monosensor device for detecting an impact and discriminating a breakage/non breakage on an automotive glazing, and/or for detecting and locating an impact and/or discriminating a breakage/non breakage on the glazing, and generating a signal representative of the said impact according to claim 1, the sensor device being connected to an electrical connector, to provide external access to the signal generated by the at least one sensor.

16. The automotive glazing according to claim 1, wherein the at least one sensor a piezo electric sensor.

17. The automotive glazing according to claim 2, wherein the multiple sensors are mounted and mechanically fixed to a printed circuit board (PCB) to form a multisensors device.

18. The automotive glazing according to claim 2, wherein the multiple sensors are aligned on a PCB to form a multisensors device.

19. The automotive glazing according to claim 1, wherein the monosensor device is fixed to the glazing on the inner face by a repositionable double sided tape.

20. The automotive glazing according to claim 18, wherein the multisensors device is removable from the glazing and reusable on another glazing.

21. The method according to claim 13, wherein the method further comprises:
extracting an impact occurrence and/or breaking and/or X and Y location of the impact/breakage when a multisensors device is used.
